(19) United States
(12) Patent Application Publication
(10) Pub. No.: US 2005/0224295 A1
(43) Pub. Date: Oct. 13, 2005

(54) Elevator

(76) Inventors: Toshiyuki Shimizu, Osaka (JP); Shiro Nakajima, Hyogo (JP)

Correspondence Address: John F Hoffman;Baker & Daniels, Suite 800, 111 East Wayne Street, Fort Wayne, IN, 46802, US

(21) Appl. No.: 10/512,654

(22) PCT Filed: Nov. 26, 2002
(86) PCT No.: PCT/JP02/12345

§ 371 Date: Nov. 18, 2004

(30) Foreign Application Priority Data
Apr. 23, 2002 (JP) 2002-120712
Apr. 23, 2002 (JP) 2002-120713
Jun. 21, 2002 (JP) 2002-182036

(51) Int. Cl. B66B 9/02

(52) U.S. Cl. 187/250

(57) ABSTRACT

An elevator comprising an elevator body secured to a building structure and provided with a winder for winding a plurality of suspenders, and an elevating/lowering section being suspended to move freely up and down by the plurality of suspenders led out from the suspender outlet of the elevator body. The elevator further comprises a tension adjuster for substantially equalizing the tensions of respective suspenders by acting on the respective suspenders located between the suspender outlet of the elevator body and the winder. The elevating/lowering section can be moved up and down in a stabilized attitude and safety is enhanced against cutting and dropping of the suspenders.

### FIELD OF THE INVENTION

The present invention relates to an elevator.

### BACKGROUND OF THE INVENTION

Conventionally, there is an elevator that is provided with an appliance attached at a high altitude and a drum for suspending an elevating/lowering section of this appliance by independent two and more suspenders and winding each of suspenders, which elevator elevates and lowers the apparatus in accordance with rotation of the drum. For example, in JP-UM-A-6-28913, an elevator having a pair of long drums provided with a driving mechanism respectively and a lighting fixture provided with a differential mechanism, in which winding a wire rope from each drum on one pulley in the differential mechanism in a U-shape and winding a wire rope from each drum on the other pulley in the differential mechanism in an X-shape, a rotation direction of each drum is controlled so as to make elevation and lowering and rotation of the light fixture possible. Thus, in a structure for suspending the elevating/lowering section of the appliance by the independent two and more suspenders of the elevator, it is necessary to make a length of each suspender approximately equal in order to elevate and lower the elevating/lowering section while keeping it approximately horizontal.

However, due to variance of a measurement of each part such as the elevating/lowering section and the drum or the like, it is difficult to make the length of each suspender approximately equal and the elevating/lowering section declines. Therefore, it is difficult to elevate and lower the elevating/lowering section safely in a stabilized attitude. In addition, in order to evade such a problem, sometimes a structure for suspending the elevating/lowering section by one suspender is adopted, however, as compared to the structure for suspending the elevating/lowering section by two and more suspenders, tension acting on one suspender is larger and this involves a problem such that safety is decreased.

In addition, according to the above-described elevator, the elevating/lowering section may turn over. Therefore, a tag suspended by a long string is attached to the elevating/lowering section so as to make it visible that the elevating/lowering section turns over and to turn back the elevating/lowering section when it turns over.

However, in this case, this involves a problem such that it is difficult to know twisting of a belt suspender even if the elevating/lowering section suspended by two belt suspenders turns over while lowering. In addition, if the elevating/lowering section elevates as turning over and is fit with the apparatus, it is feared that the belt suspender is damaged since it is twisted. Therefore, it is preferable that the elevating/lowering section is structured so as not to turn over while lowering.

In addition, a shaft to support a pair of right and left winders in the elevator is supported to rotate freely by a sliding bearing. The sliding bearing is formed in such a manner that a bearing fitting concave portion is formed on a bearing table and an acceptance part through which the shaft is inserted is formed on this bearing fitting concave portion. In other words, as shown in FIG. 18, a bearing fitting concave portion 41′ is formed on a bearing table 31′ to support a sliding bearing 32′ and a sliding bearing 32′ having an acceptance portion 51′ formed on a center thereof is fit in the bearing fitting concave portion 41′.

However, since the bearing fitting concave portion 41′ and the bearing table 31′ to be formed on the bearing table 31′ is formed by machine processing so as to be made in a circle as seen from an axial direction, a fitting portion of the bearing table 31′ and the sliding bearing 32′ is made a curved surface so that measuring of the fitting portion becomes difficult, and a fine accuracy of measuring is needed and this makes management of measuring difficult.

In addition, the sliding baring is cheaper than a rolling bearing, however, there is a gap between the shaft and the bearing so that a foreign matter such as dust gets mixed therein and a rotation efficiency tends to be deteriorated. As a result, such a sliding bearing cannot be used in an adverse environment that dust is floating in air.

### DISCLOSURE OF THE INVENTION

Accordingly, a first object of the present invention is to provide an elevator capable of elevating and lowering in a stabilized attitude while keeping an elevating/lowering section substantially horizontal by providing a structure for absorbing a difference of a length even if there is a difference in the length of each independent suspender.

A second object of the present invention is to provide an elevator for preventing the elevating/lowering section from turning over while lowering and a belt suspender from being twisted.

A third object of the present invention is to provide an elevator, which can make a fitting portion of a bearing table and a sliding bearing into a plane surface in the sliding bearing to be used for a rotational shaft of a winder so as to improve accuracy of measuring and accuracy of management of measuring and which also can be used in an adverse environment that dust or the like is floating in air.

In order to solve the above-described problem, the present invention described in claim 1 may provide an elevator comprising an elevator body secured to a building structure and provided with a winder for winding a plurality of suspenders, and an elevating/lowering section being suspended to move freely up and down by the plurality of suspenders led out from the suspender outlet of the elevator body; wherein the elevator further comprises a tension adjuster for substantially equalizing the tensions of respective suspenders by acting on the respective suspenders located between the suspender outlet of the elevator body and the winder.

Thus, since the elevator is provided with the tension adjuster for substantially equalizing the tensions of respective suspenders by acting on the respective suspenders located between the suspender outlet of the elevator body and the winder, when there is a difference of a length in each suspender, the largest tension acts on a shorter suspender, however, the tension adjuster functions so as to ease up this tension. Therefore, it is possible to hold the elevating/lowering section substantially horizontally by independent plural suspenders without inclination. As a result, the elevating/lowering section can be moved up and down in a stabilized attitude and safety is enhanced against cutting and dripping of the suspenders.

According to an elevator described in claim 2 as in the elevator of claim 1, the tension adjuster is provided with a change-direction member for changing a direction of the suspender to move freely for each suspender between the suspender outlet of the elevator body and the winder, and a spring body with a substantially equal spring constant for adding a return force corresponding to the movement of each change-direction member thereto, respectively.

Thus, since the tension adjuster is provided with a change-direction member for changing a direction of the suspender to move freely for each suspender between the suspender outlet of the elevator body and the winder, and a spring body with a substantially equal spring constant for adding a return force corresponding to the movement of each change-direction member thereto, respectively; the spring body holding the change-direction member of the shorter suspender bends, so that there is no difference of the length of the suspender in appearance and a suspension attitude of the elevating/lowering section is kept substantially horizontal.

According to an elevator described in claim 3 as in the elevator of claim 1, there are two suspenders, the tension adjuster is provided with a change-direction member for changing a direction of the suspender for each suspender between the suspender outlet of the elevator body and the winder, and the change-direction members of respective suspenders united into one body by the same shaft is provided with a support member for supporting the shaft to swing freely with a center portion between the change-direction members of this shaft as a supporting point.

Thus, since there are two suspenders, the tension adjuster is provided with a change-direction member for changing a direction of the suspender for each suspender between the suspender outlet of the elevator body and the winder, and the change-direction members of respective suspenders united into one body by the same shaft is provided with a support member for supporting the shaft to swing freely with a center portion between the change-direction members of this shaft as a supporting point, when there is a difference of a length in the two suspenders, the tensions of the suspenders are different, so that the shaft is inclined like a seesaw to intend to keep the tensions equal respectively. Thereby, there is no difference of the lengths of the two suspenders in appearance and the suspension attitude of the elevating/lowering section is kept substantially horizontal.

According to an elevator described in claim 4 as in the elevator of claim 1, there are two suspenders, a first change-direction member for changing the direction of the suspender between the suspender outlet of the elevator body and the winder is provided, the tension adjuster comprises second change-direction members located between the first change-direction member and the winder, which change the direction of the suspender and are united into one body each other by the same shaft, and a support member for supporting the shaft to swing freely with a center portion between the second change-direction members of the shaft as a supporting point.

Thus, since there are two suspenders, a first change-direction member for changing the direction of the suspender between the suspender outlet of the elevator body and the winder is provided, the tension adjuster comprises second change-direction members located between the first change-direction member and the winder, which change the direction of the suspender and are united into one body each other by the same shaft, and a support member for supporting the shaft to swing freely with a center portion between the second change-direction members of the shaft as a supporting point, when there is a difference of a length in the two suspenders, the tensions of the suspenders are different, the shaft uniting the second change-direction members into one unit is inclined like a seesaw to intend to keep the tensions equal respectively. Thereby, there is no difference of the lengths of the two suspenders in appearance and the suspension attitude of the elevating/lowering section is kept substantially horizontal. In addition, by providing the shaft to swing freely between the suspender and the change-direction member, load acting on the shaft becomes a divided force of the tension of the suspender, so that a force is weak and the intense shaft strength is not needed, and this makes it possible to lower a cost of the parts.

According to an elevator described in claim 5 as in the elevator of claim 4, the second change-direction member is provided with a spring body, which is movably provided in an opposite direction of a support side of the support member and which applies a force to the opposite direction of the support side of the support member together with the shaft; and the second change-direction member is further provided with a switch operating as abutting against the shaft when the tension of the suspender is made small and the second change-direction member moves with the force of the spring body applied thereto so as to stop winding off of the suspender from the suspender by this switch.

Thus, since the second change-direction member is provided with a spring body, which is movably provided in an opposite direction of a support side of the support member and which applies a force to the opposite direction of the support side of the support member together with the shaft; and the second change-direction member is further provided with a switch operating as abutting against the shaft when the tension of the suspender is made small and the second change-direction member moves with the force of the spring body applied thereto so as to stop winding off of the suspender from the suspender by this switch, when winding the suspender into the winder with a light load acting on the elevating/lowering section, the appropriate tension is applied to the suspender and this makes it possible to stably wind the suspender in tight.

According to an elevator described in claim 6 as in the elevator of claim 4, in the first change-direction member, the shaft is held to move freely by a spring body to apply a force to the opposite direction of the side pressed by the tension of the suspender; and the first change-direction member is provided with a switch operating as abutting against the shaft when a force more than a set tension is applied to the suspender and the shaft pushes down the spring body to move the spring body so as to stop winding of the suspender into the winder by this switch.

Thus, since in the first change-direction member, the shaft is held to move freely by a spring body to apply a force to the opposite direction of the side pressed by the tension of the suspender; and the first change-direction member is provided with a switch operating as abutting against the shaft when a force more than a set tension is applied to the suspender and the shaft pushes down the spring body to move the spring body so as to stop winding of the suspender into the winder by this switch, moving up and down is stopped and it is possible to prevent winding of the suspender when a load is excessively given. In addition, by using the apparatus for stopping excess load as a detection mechanism for stopping the elevating/lowering section when it is fit in the elevator body, it is possible to make a suspender winding pressure of the winder intense when the elevating/lowering section is fit in the elevator body and the elevating/lowering section can be held without loose.

According to an elevator described in claim 7 as in the elevator of claim 3, the change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides.

Thus, since the change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides, the change-direction member is inclined in an opposite direction with respect to inclination of the shaft. Therefore, the rotating body is inclined in an opposite direction against the inclination of the shaft, so that it is possible to pass the suspender while being winded on the rotating body in a stabilized attitude.

According to an elevator described in claim 8 as in the elevator of claim 4, the second change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides.

Thus, since the second change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides, the change-direction member is inclined in an opposite direction with respect to inclination of the shaft. Therefore, the rotating body is inclined in an opposite direction against the inclination of the shaft, so that it is possible to pass the suspender while being winded on the rotating body in a stabilized attitude.

According to an elevator described in claim 9 as in the elevator of claim 1, the two suspenders are two belts and the elevator is provided with a jumping-out prevention member for preventing each suspender from jumping out to the outside of the elevating/lowering section when the elevating/lowering section turns over in a direction to wind these two suspenders.

Thus, since the above-described change-direction member is provided, and the elevator is provided with a jumping-out prevention member for preventing each suspender from jumping out to the outside of the elevating/lowering section when the elevating/lowering section turns over in a direction to wind these two suspenders, it is possible to evade the case that the elevating/lowering section is fit with the elevator body when the elevating/lowering section turns over and the belt suspender moves up as twisted. Therefore, the elevating/lowering section can move up and down in a stabilized attitude, safety is enhanced against cutting and dropping of the suspenders, the belt suspender is not damaged, and the strength of the suspender is kept, so that it is possible to suspend the elevating/lowering section safely.

According to an elevator described in claim 10 as in the elevator of claim 9, the jumping-out prevention member comprises a wall body that is disposed along the side surface at the outside of a suspender attached portion for attaching the suspender of the elevating/lowering section.

Thus, since the jumping-out prevention member comprises a wall body that is disposed along the side surface at the outside of a suspender attached portion for attaching the belt suspender of the elevating/lowering section, when the elevating/lowering section nearly turns over, the belt suspender is prevented from running out and jumping out laterally from the elevating/lowering section by the wall body and twist of the belt suspender is also prevented.

According to an elevator described in claim 11 as in the elevator of claim 9, the jumping-out prevention member comprises a bar member that is arranged in a substantially horizontal direction at the outside of the suspender attached portion for attaching the suspender of the elevating/lowering section.

Thus, since the jumping-out prevention member comprises a bar member that is arranged in a substantially horizontal direction at the outside of the suspender attached portion for attaching the suspender of the elevating/lowering section, when the elevating/lowering section nearly turns over, the belt suspender is prevented from running out and jumping out laterally from the elevating/lowering section by the bar member and twist of the belt suspender is also prevented.

According to an elevator described in claim 12 as in the elevator of claim 9, the jumping-out prevention member comprises a bar member that is arranged in a substantially vertical direction at the outside of the suspender attached portion for attaching the suspender of the elevating/lowering section.

Thus, since the jumping-out prevention member comprises a bar member that is arranged in a substantially vertical direction at the outside of the suspender attached portion for attaching the suspender of the elevating/lowering section, the belt suspender is prevented from running out and jumping out laterally from the elevating/lowering section by the bar member and twist of the belt suspender is also prevented.

According to an elevator described in claim 13 as in the elevator of claim 1, a bearing fitting concave portion opening upward is formed on a bearing table to be used as a rotating shaft of the winder; a sliding bearing portion forming an acceptance portion through which the rotating shaft is inserted is fit in the bearing fitting concave portion; and a sliding bearing for securing the sliding bearing portion fit in the bearing fitting concave portion from the upper part therein by a cover portion is mounted; wherein the bearing fitting concave portion and the sliding bearing portion are formed in a multiangular as viewed from an axial direction.

Thus, since the above-described tension adjuster is provided and the sliding bearing portion is configured as described above, the elevating/lowering section can move up and down in a stabilized attitude, safety is enhanced against cutting and dropping of the suspenders, and it is possible to make a fitting portion of the bearing table and the sliding bearing portion (namely, the outer surface of the sliding bearing portion and the inner surface of the bearing fitting concave portion of the bearing table) not into a curved surface but into a flat surface. As a result, accuracy of measuring and accuracy of management of measuring are improved.

According to an elevator described in claim 14 as in the elevator of claim 13, a projection part to be welded with pressure downward on an upper end portion of the sliding bearing portion by a cover portion is provided at a place evading the rotating shaft as viewed from a flat plane.

Thus, since the sliding bearing portion is configured as described above, it is possible to reliably and strongly put and fix the sliding bearing portion between the bearing table and the cover portion.

According to an elevator described in claim 15 as in the elevator of claim 14, the plural projection parts are linearly provided in substantially parallel.

Thus, since the sliding bearing portion is configured as described above, it is possible to reduce deformation of the acceptance portion and lowering of a rotation efficiency of the rotating shaft can be prevented. Further, a fixing force is obtained at the both right and left sides, so that the sliding bearing portion can be safely fixed.

According to an elevator described in claim 16 as in the elevator of claim 13, a concave portion opening to the side is formed at both ends in the axial direction and across the entire periphery of the acceptance portion of the sliding bearing portion, and a filter for preventing dust is provided on the concave portion so as to closely contact the rotating shaft.

Thus, since the sliding bearing portion is configured as described above, no foreign matter gets mixed in the acceptance portion of the sliding bearing, so that it is possible to hold the rotating shaft stably for a long period of time.

According to an elevator described in claim 17 as in the elevator of claim 9, a bearing fitting concave portion opening upward is formed on a bearing table to be used as a rotating shaft of the winder; a sliding bearing portion forming an acceptance portion through which the rotating shaft is inserted is fit in the bearing fitting concave portion; and a sliding bearing for securing the sliding bearing portion fit in the bearing fitting concave portion from the upper part therein by a cover portion is mounted; wherein the bearing fitting concave portion and the sliding bearing portion are formed in a multiangular as viewed from an axial direction.

Thus, the above-described tension adjustor and jumping-out prevention member are provided and the sliding bearing portion is configured as described above, the elevating/lowering section can be moved up and down in a stabilized attitude, safety is enhanced against cutting and dripping of the suspenders, the strength of the suspender is kept with no damage on the belt suspender, and the elevating/lowering section can be suspended safely. In addition, it is possible to make a fitting portion of the bearing table and the sliding bearing portion (namely, the outer surface of the sliding bearing portion and the inner surface of the bearing fitting concave portion of the bearing table) not into a curved surface but into a flat surface. As a result, accuracy of measuring and accuracy of management of measuring are improved.

According to an elevator described in claim 18 as in the elevator of claim 17, a projection part to be welded with pressure downward on an upper end portion of the sliding bearing portion by a cover portion is provided at a place evading the rotating shaft as viewed from a flat plane.

Thus, since the sliding bearing portion is configured as described above, it is possible to reliably and strongly put and fix the sliding bearing portion between the bearing table and the cover portion.

According to an elevator described in claim 19 as in the elevator of claim 18, the plural projection parts are linearly provided in substantially parallel.

Thus, since the sliding bearing portion is configured as described above, it is possible to reduce deformation of the acceptance portion and lowering of a rotation efficiency of the rotating shaft can be prevented. Further, a fixing force is obtained at the both right and left sides, so that the sliding bearing portion can be safely fixed.

According to an elevator described in claim 20 as in the elevator of claim 17, a concave portion opening to the side is formed at both ends in the axial direction and across the entire periphery of the acceptance portion of the sliding bearing portion, and a filter for preventing dust is provided on the concave portion so as to closely contact the rotating shaft.

Thus, since the sliding bearing portion is configured as described above, no foreign matter gets mixed in the acceptance portion of the sliding bearing, so that it is possible to hold the rotating shaft stably for a long period of time.

### BRIEF DESCRIPTION OF THE DRAWINGS

FIG. 1 is a conceptual illustration showing an elevator according to a first embodiment of the present invention.

FIG. 2 is an entire side view showing the elevator shown in FIG. 1.

FIG. 3 is an explanatory view showing the operation of the elevator according to the first embodiment of the present invention.

FIG. 4 is a conceptual illustration showing an elevator according to a second embodiment of the present invention.

FIG. 5 is a sectional view showing a change-direction member shown in FIG. 4.

FIG. 6 is a substantial part perspective view showing an elevator according to a third embodiment of the present invention.

FIG. 7 is a substantial part explanatory view showing an elevator according to a fourth embodiment of the present invention.

FIG. 8 is a substantial part explanatory view showing an elevator according to a fifth embodiment of the present invention.

FIG. 9 is an explanatory view showing the operation of an elevator according to a sixth embodiment of the present invention.

FIG. 10 is an explanatory view showing the operation of the elevator according to the sixth embodiment of the present invention.

FIG. 11 is a perspective view showing an elevating/lowering section of an elevator according to a seventh embodiment of the present invention.

FIG. 12 is a perspective view showing an elevating/lowering section of an elevator according to an eighth embodiment of the present invention.

FIG. 13 is an exploded perspective view showing a sliding bearing of an elevator according to a ninth embodiment of the present invention.

FIG. 14 is a sectional view of the sliding bearing of the elevator shown in FIG. 13.

FIG. 15 is an exploded perspective view showing a sliding bearing of an elevator according to a tenth embodiment of the present invention.

FIG. 16 is a sectional view of the sliding bearing of the elevator shown in FIG. 15.

FIG. 17 is a schematic sectional view showing a shaft supporting structure of a winder of the elevator of the present invention.

FIG. 18 is a schematic sectional view showing a sliding bearing of a conventional elevator.

### BEST MODE FOR CARRYING OUT THE INVENTION

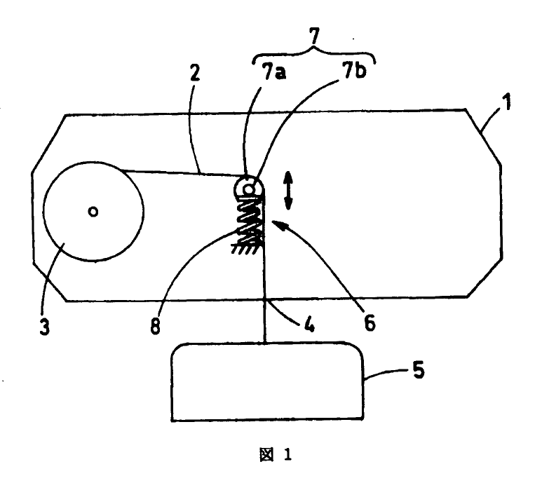

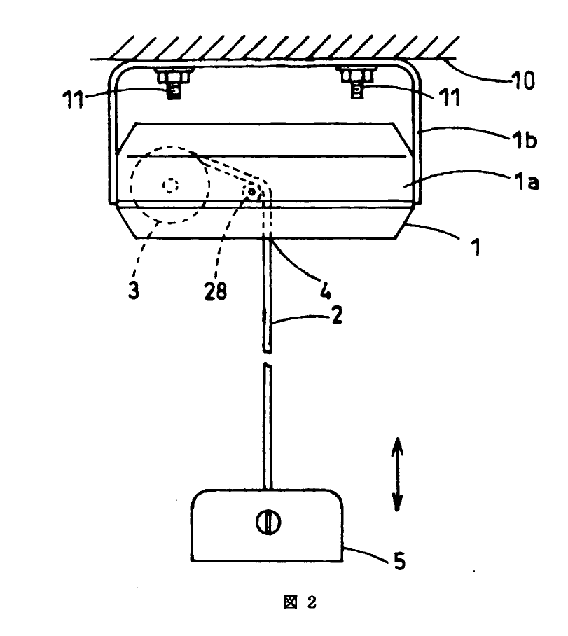

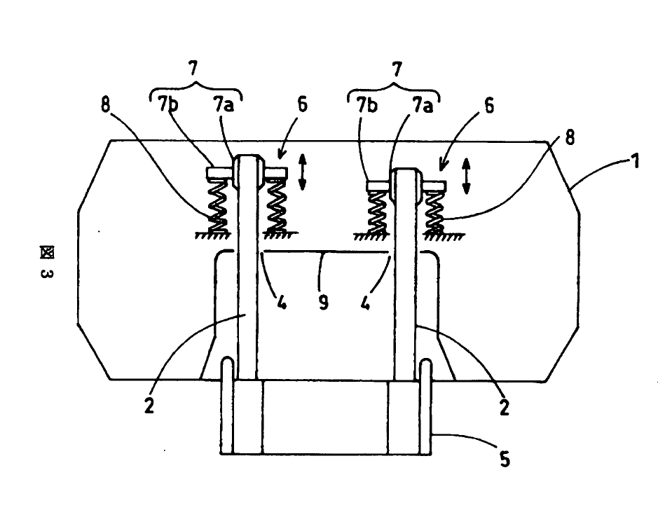

At first, with reference to the drawings, the embodiment(s) mainly related to a tension adjuster will be described below. FIG. 1 is a conceptual illustration showing an elevator according to a first embodiment of the present invention, FIG. 2 is an entire side view showing the elevator shown in FIG. 1, and FIG. 3 is an explanatory view showing the operation of the elevator according to the first embodiment of the present invention.

As shown in FIGS. 1 to 3, an elevator body 1 secured to a building structure is provided with a winder 3 for winding a plurality of suspenders 2 and an elevating/lowering section 5 is suspended to move freely up and down by the plurality of suspenders 2 led out from a suspender outlet 4 of the elevator body 1. In this case, the plurality of suspenders 2 is made of a thin plate steel shaped like a belt. The winder 3 comprises a drum for winding or winding off the suspender 2 and the winder 3 is provided corresponding to the number of the suspenders 2. In this structure, a tension adjuster 6 for substantially equalizing the tensions of respective suspenders 2 by acting on the respective suspenders 2 located between the suspender outlet 4 of the elevator body 1 and the winder 3 is provided.

The tension adjuster 6 is configured in such a manner that a change-direction member 7 for changing a direction of the suspender 2 is provided to move freely at least in a direction of elevating and lowering of the elevating/lowering section 5 for each suspender 2, and the change-direction member 7 is provided with a spring body 8 with a substantially equal spring constant for adding a return force corresponding to the movement of each change-direction member 7 thereto, respectively.

The change-direction member 7 comprises a pulley 7a that is supported around a shaft 7b to move freely. In this case, two suspenders 2 are winded off from respective winders 3 to lead to the both ends of the elevating/lowering section 5 via the pulley 7a to change the direction of the suspender 2 downward. In addition, respective shaft 7b to hold the pulley 7a is held by the spring body 8 having a prescribed force. The spring body 8 is a compression coil spring arranged so as to hold the both ends of the shaft 7b and its one end is secured to the shaft 7b and other end thereof is secured to a region of the elevator body 1. The elevator body 1 has a concave portion 9 for housing the elevating/lowering section 5 at a position facing to the suspender outlet 4. In this case, as shown in FIG. 2, an outline part 1a provided with the winder 3 and the tension adjuster 6 or the like of the elevator body 1 is held by an arm part 1b and this arm part 1b is secured to a bolt 11 embedded in a ceiling 10 as a building structure.

In the next place, the operation of the elevator body provided with the above-described tension adjuster 6 will be described below. As shown in FIG. 3, when there is a difference of a length in each suspender 2, the most intense tension acts on the shorter suspender 2 and the tension adjuster 6 functions so as to ease up this tension. In other words, the spring body 8 holding the shaft 7b of the pulley 7a with the short suspender 2 bends the most, so that there is no difference of the length of the suspender 2 in appearance and a suspension attitude of the elevating/lowering section 5 is kept substantially horizontal.

As described above, according to the elevator of the first embodiment, it is possible to hold the elevating/lowering section 5 by the independent plural suspenders without inclination. As a result, the elevating/lowering section 5 can be moved up and down in a stabilized attitude and safety is enhanced against cutting and dropping of the suspender 2. In the meantime, the two and more suspenders 2 may be available.

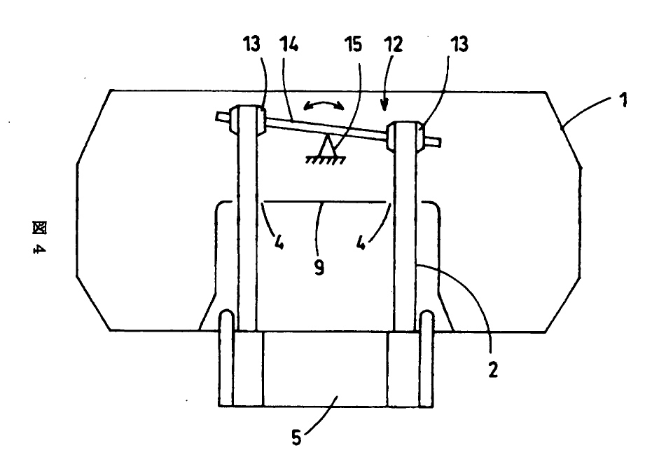

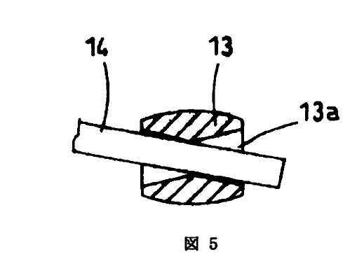

The elevator according to a second embodiment will be described with reference to FIG. 4 and FIG. 5 below. FIG. 4 is a conceptual illustration showing an elevator according to the second embodiment of the present invention, and FIG. 5 is a sectional view of a change-direction member 13 of the elevator according to the second embodiment.

As shown in FIG. 4, in the elevator, there are two suspenders 2. In addition, a tension adjuster 12 located between the suspender outlet 4 of the elevator body 1 and the winder 3 is provided with the change-direction member 13 for changing the direction of the suspender 2 at each suspender 2, and the change-direction member 13 of each suspender 2 united into one body by the same shaft 14 is provided with a support member 15 for supporting the shaft 14 to swing freely with a center portion between the change-direction members 13 of this shaft 14 as a supporting point.

As shown in FIG. 5, the change-direction member 13 is made of a pulley (a rotating body) rotating with the shaft 14 inserted therethrough. A shaft inserted portion 13a of this rotating body 13 is shaped in a taper so that its diameter is the smallest at the substantial center portion and the diameter becomes gradually larger toward the opposite sides. In this case, two suspenders 2 are winded off from respective winders 3 to lead to the both ends of the elevating/lowering section 5 via the rotating body 13 to change the direction of the suspender 2 downward. The rotating body 13 is held by the support member 15 so that it can be inclined like a seesaw. The support member 15 is secured to a region of the elevator body 1.

In the next place, the operation of the elevator according to the second embodiment will be described below. As shown in FIG. 4, if there is a difference of a length in the two suspenders 2, the tensions of the suspenders 2 are different, so that the shaft 14 of the rotating body 13 is inclined like a seesaw to keep the tensions equal respectively. Thereby, there is no difference of the length of the suspender 2 in appearance and a suspension attitude of the elevating/lowering section 5 is kept substantially horizontal. According to this embodiment, the rotating body 13 is inclined in an opposite direction against the inclination of the shaft 14, so that it is possible to pass the suspender 2 while being winded on the rotating body 13 in a stabilized attitude (substantially horizontal attitude). Other structural effects are the same as the case of the elevator according to the first embodiment.

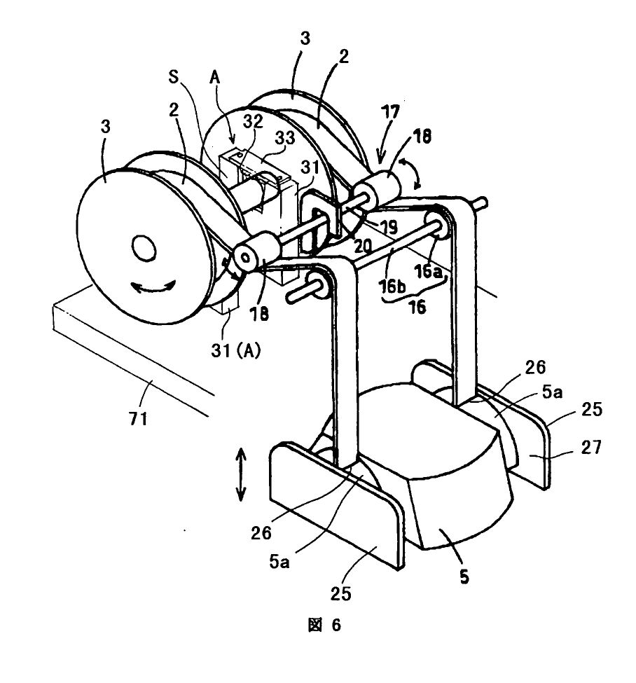

An elevator according to a third embodiment will be described with reference to FIG. 6 below. FIG. 6 is a substantial part perspective view showing the elevator according to the third embodiment of the present invention.

As shown in FIG. 6, there are two suspenders 2 in the elevator. In addition, a first change-direction member 16 for changing the direction of the suspender 2 downward between the suspender outlet 4 of the elevator body 1 and the winder 3 is provided. The first change-direction member 16 comprises a pulley 16a that is supported around a shaft 16b to rotate freely. In this case, two pulleys 16a are united into one body by one shaft 16b, however, this shaft 16b may be provided for each pulley 16a.

The tension adjuster 17 comprises second change-direction members 18 located between the first change-direction member 16 and the winder 3, which change the direction of the suspender 2 and are united into one body each other by the same shaft 19, and a support member 20 for supporting the shaft 19 to swing freely with a center portion between the second change-direction members 18 of the shaft 19 as a supporting point. In this case, two suspenders 2 are winded off from respective winders 3 to lead to the both ends of the elevating/lowering section 5 via the pulley 16a to change the direction of the suspender 2 downward. Between the winder 3 and the pulley 16a of the first change-direction member 16, the tension adjuster 17 is provided, in which the second change-direction members 18 are held by a support member 20 so that it can be inclined by the same shaft 19 like a seesaw. In addition, the second change-direction member 18 is a pulley that is structured as same as the change-direction members shown in FIG. 5 according to the second embodiment and the second change-direction member 18 abuts against the side opposite to the side, against which the first change-direction member 16 of the suspender 2 abuts. The support member 20 is secured to the elevator body 1 to position the shaft 19 so as to prevent the second change-direction member 18 from being separated from the suspender 2.

In the next place, the operation of the elevator according to the third embodiment will be described below. If there is a difference of a length in the two suspenders 2, the tensions of the suspenders 2 are different, so that the tension adjuster 17 is inclined like a seesaw to keep the tensions equal respectively. For example, the intense tension acts on the shorter suspender 2, so that the second change-direction member 18 abutting against this suspender 2 moves upward. In response to this, the second change-direction member 18 at the opposite side moves downward, the suspender 2 at the opposite side abutting against this is pulled to absorb the length of the suspender 2 between the suspender 3 and the second change-direction member 18. Thereby, there is no difference of the length of the suspender 2 in appearance and a suspension attitude of the elevating/lowering section 5 is kept substantially horizontal. According to this embodiment, the pulley 18 is inclined in an opposite direction against the inclination of the shaft 19, so that it is possible to pass the suspender 2 while being winded on the pulley 18 in a stabilized attitude (substantially horizontal attitude).

In addition, by providing the shaft 19 to swing freely between the suspender 3 and the change-direction member 16, a load acting on the shaft 19 becomes a divided force of the tension of the suspender 2, so that a force is weak and the intense shaft strength is not needed, and this makes it possible to lower a cost of the parts. Other structural effects are the same as the case of the elevator according to the first embodiment.

In the next place, a structure to make the moving up and down operation more safe by adding a function to stop winding and winding off of the suspender 2 while detecting a size of the tension of the suspender 2 to a mechanism for absorbing the length of the suspender 2 is shown in fourth and fifth embodiments

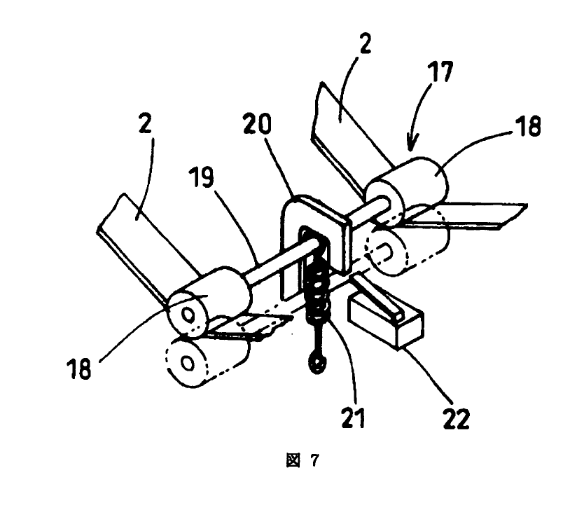

The fourth embodiment of the present invention will be described with reference to FIG. 7 below. FIG. 7 is a substantial part explanatory view showing an elevator according to a fourth embodiment of the present invention.

As shown in FIG. 7, according to the third embodiment, the second change-direction member 18 of the tension adjuster 17 is provided with a spring body 21, which is located in an opposite direction of a support side of the support member 20 and which applies a force to the opposite direction of the support side of the support member 20 together with the shaft 19. In other words, the shaft 19 is pulled by the spring body 21 to a direction reacting against the tension of the suspender 2. In addition, the second change-direction member is further provided with a switch 22 operating as abutting against the shaft 19 when the tension of the suspender 2 is made small and the second change-direction member 18 moves with the force of the spring body 21 applied thereto so as to stop winding off of the suspender from the suspender 3 by this switch 22.

With respect to the above-described elevator, the operation when there is a difference of the length in the two suspenders 2 is the same as the third embodiment. In addition, if the tension of the suspender 2 is made smaller when the elevating/lowering section 5 touches a floor, the shaft 19 is moved by the spring body 21 as shown by a chain double-dashed line to push the switch 22 for stopping winding off of the suspender 2, so that the moving up and down operation is stopped and the suspender 2 is prevented from excessively winded off.

According to this fourth embodiment, when winding the suspender 2 into the winder 3 with a light load acting on the elevating/lowering section 5, the appropriate tension is applied to the suspender 2 and this makes it possible to stably wind the suspender 2 in tight. Other structural effects are the same as the case of the elevator according to the first embodiment and the third embodiment.

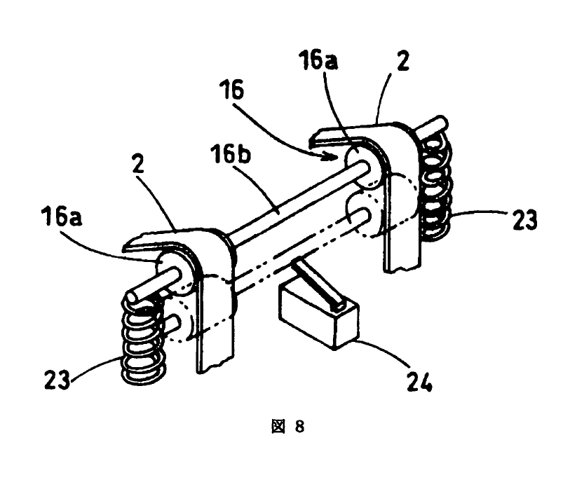

A fifth embodiment of the present invention will be described with reference to FIG. 8 below. FIG. 8 is a substantial part explanatory view showing an elevator according to the fifth embodiment of the present invention.

As shown in FIG. 8, according to the third embodiment, an apparatus for stopping excess load is provided. In other words, in the first change-direction member 16, the shaft 16b is held to move freely by a spring body 23 to apply a force to the opposite direction of the side pressed by the tension of the suspender 2. In this case, two pulleys 16a of the first change-direction member 16 are united into one body by one shaft 16b. The opposite ends of this shaft 16 are supported by the spring body 23. In addition, the first change-direction member is provided with a switch 24 operating as abutting against the shaft 16b when a force more than a set tension is applied to the suspender 2 and the shaft 16b pushes down the spring body 23 to move the spring body 23 so as to stop winding of the suspender 2 into the winder 3 by this switch 24.

With respect to the above-described elevator, the operation when there is a difference of the length in the two suspenders 2 is the same as the third embodiment. In addition, if the tension of the suspender 2 is made larger, the shaft 16b pushes the spring body 23 and the spring body 23 is moved as shown by a chain double-dashed line, so that the switch 24 for stopping winding of the suspender 2 is pushed, the moving up and down operation is stopped and the suspender 2 is prevented from excessively winded.

According to this fifth embodiment, by using the apparatus for stopping excess load as a detection mechanism for stopping the elevating/lowering section 5 when it is fit in the elevator body 1, it is possible to make a suspender winding pressure of the winder 3 intense when the elevating/lowering section 5 is fit in the elevator body 1 and the elevating/lowering section 5 can be held without loose. Other structural effects are the same as the case of the elevator according to the first embodiment and the third embodiment.

In the meantime, the present embodiment may be structured so as to have the both of the fourth embodiment and the fifth embodiment. In addition, the suspender 2 may be a wire other than a belt.

It is preferable that the elevator according to the present invention includes the two suspenders as two belts in addition to the above-described tension adjuster and that the elevator according to the present invention is provided with a jumping-out prevention member for preventing each suspender from jumping out to the outside when the elevating/lowering section turns over in a direction to wind these two suspenders. With reference to the drawings, the embodiments with related to the elevator with the jumping-out prevention member mainly disposed thereto. At first, a sixth embodiment will be described with reference to FIGS. 2, 6, 9, and 10. FIG. 2 is an entire side view showing the elevator, and FIG. 6 is a substantial part perspective view including the elevating/lowering section.

As shown in FIG. 2 and FIG. 6, the elevator body 1 secured to the building structure is provided with the winder 3 of the suspender 2 as two belts (hereinafter, referred to as a belt suspender 2), and two belt suspenders 2 led out from the elevator body 1 suspend the elevating/lowering section 5 to move up and down freely. In this case, the two belt suspenders 2 are made of a thin plate steel or the like and they are led out from the suspender outlet 4 of the elevator body 1 with the faces in a width direction uniformed. In this structure, a jumping-out prevention member 25 for preventing each suspender 2 from jumping out to the outside of the elevating/lowering section 5 when the elevating/lowering section turns over in a direction winding two belt suspenders 2 is provided.

This jumping-out prevention member 25 comprises a wall body that is disposed along the side surface at the outside of a suspender attached portion 26 for attaching the belt suspender 2 of the elevating/lowering section 5. In this case, projection parts 5a protruding by substantially the same measurement as a width of the belt suspender 2 are formed at the both sides of the elevating/lowering section 5 and the suspender attached portion 26 is arranged on this projection part 5a. In addition, a wall body 25 is formed at the end surface of the projection part 5a in a shape of a sword guard. The inner side surface of the wall body 25 faces to the side surface of the elevating/lowering section 5 formed around the projection part 5a and a space 27 having the belt suspender 2 put therein is formed between the inner side surface of the wall body 25 and the side surface of the elevating/lowering section 5.

The elevator body 1 has a concave portion (not illustrated) for housing the elevating/lowering section 5 in a place facing to the suspender outlet 4. In this case, as shown in FIG. 2, the outline part 1a provided with the winder 3 of the elevator body 1 or the like is held by the arm part 1b and this arm part 1b is secured to the bolt 11 embedded in the ceiling 10 as a building structure. The winder 3 comprises a drum for winding or winding off the suspender 2 and two winders 3 are disposed corresponding to two belt suspenders 2. In addition, a direction of the belt suspender 2 is changed between the suspender outlet 4 of the elevator body 1 and the winder 3.

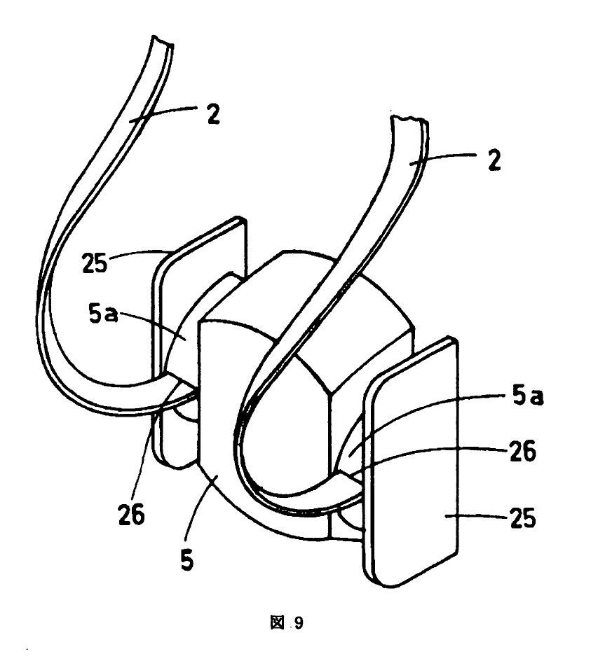

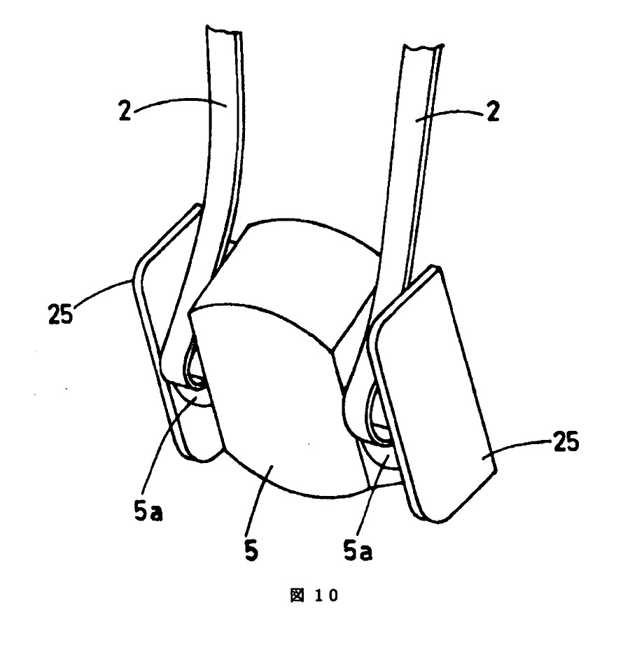

FIG. 9 and FIG. 10 are explanatory views showing the operation of an elevator according to a sixth embodiment of the present invention. As shown in FIG. 9 and FIG. 10, if the elevating/lowering section 5 nearly turns over, the belt suspender 2 is prevented from running out and jumping out laterally from the elevating/lowering section 5 by the wall body 25 and twist of the belt suspender 2 is also prevented. In addition, even if the elevating/lowering section 5 turns over and the belt suspender 2 is winded around the projection part 5a, the elevating/lowering section 5 is rotated by its own weight and becomes normal again. Accordingly, it is possible to evade the case that the elevating/lowering section 5 is fit with the elevator body 1 when the elevating/lowering section 5 turns over and the belt suspender 2 moves up as twisted. Therefore, the belt suspender 2 is not damaged and the strength of the suspender is kept, so that it is possible to suspend the elevating/lowering section 5 safely.

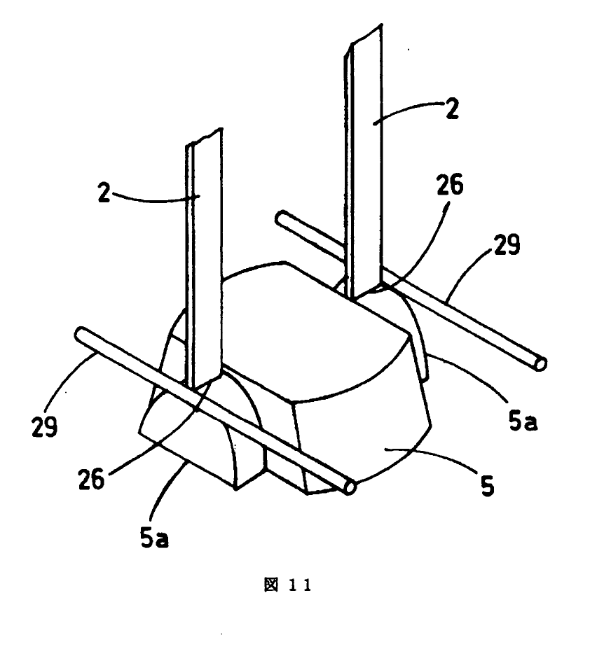

A seventh embodiment of the present invention will be described with reference to FIG. 11. FIG. 11 is a perspective view showing an elevating/lowering section of an elevator according to the seventh embodiment of the present invention.

As shown in FIG. 11, according to the first embodiment, the jumping-out prevention member comprises a bar (liner) member 29 that is arranged in a substantially horizontal direction at the outside of the suspender attached portion 26 for attaching the belt suspender 2 of the elevating/lowering section 5. In this case, the bar member 29 is arranged in a substantially orthogonal direction with respect to the surface in the width direction of the belt suspender 2, and the center portion of the bar member 29 is secured on the end surface of the elevating/lowering section 5 in the vicinity of the suspender attached portion 26. In addition, one end side and other end side of the bar member 29 are arranged with facing each other on the side surface of the elevating/lowering section 5 that is formed around the projection parts 5a.

According to this seventh embodiment, if the elevating/lowering section 5 nearly turns over, the belt suspender 2 is prevented from running out and jumping out laterally from the elevating/lowering section 5 by the bar member 29 and twist of the belt suspender 2 is also prevented. In this case, it is possible to regulate running out of the belt suspender 2 at both of one end side and other end side of the bar member 29. Other structural effects are the same as the case of the elevator according to the first embodiment. In the meantime, the both end portions of the bar member 29 may be bent in a rotation direction of the elevating/lowering section 5.

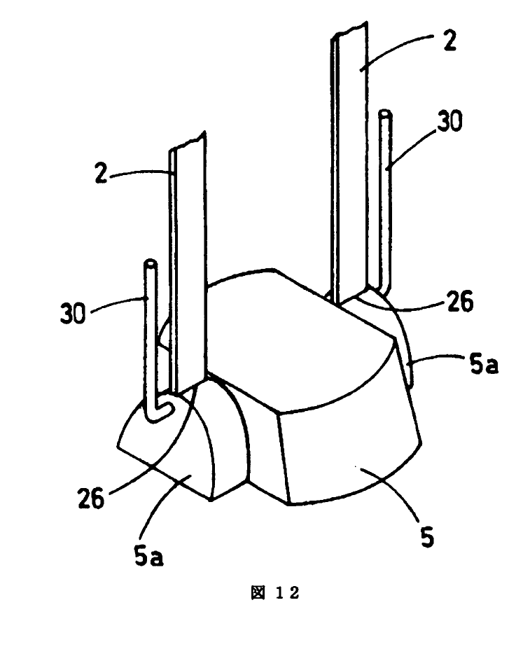

An eighth embodiment of the present invention will be described with reference to FIG. 12. FIG. 12 is a perspective view showing an elevating/lowering section of an elevator according to the eighth embodiment of the present invention.

As shown in FIG. 12, in the sixth embodiment, the jumping-out prevention member comprises a bar (linear) member 30 that is arranged in a substantially vertical direction at the outside of the suspender attached portion 26 where the belt suspender 2 of the elevating/lowering section 5 is attached. In this case, the bar member 30 is arranged along a longitudinal direction of the belt suspender 2, and a bending base end portion of the bar member 30 is secured to the end surface of the projection parts 5a in the vicinity of the suspender attached portion 26. In addition, the front end side of the bar member 30 is arranged upward as facing to the end surface of the belt suspender 2.

According to this eighth embodiment, if the elevating/lowering section 5 nearly turns over, the belt suspender 2 is prevented from running out and jumping out laterally from the elevating/lowering section 5 by the bar member 30 and twist of the belt suspender 2 is also prevented. In this case, since the bar member 30 is always arranged in the vicinity of the front end portion of the belt suspender 2, it is possible to effectively regulate running out of the belt suspender 2. Other structural effects are the same as the case of the elevator according to the first embodiment. In the meantime, the front end portion of the bar member 30 may be bent in a rotation direction of the elevating/lowering section 5.

In the elevator of the present invention, in addition to the above-described tension adjuster, further, a bearing fitting concave portion opening upward is formed on a bearing table to be used as a rotating shaft of the winder, a sliding bearing portion forming an acceptance portion through which the rotating shaft is inserted is fit in the bearing fitting concave portion, and the sliding bearing for securing the sliding bearing portion fit in the bearing fitting concave portion from the upper part therein by a cover portion is mounted.

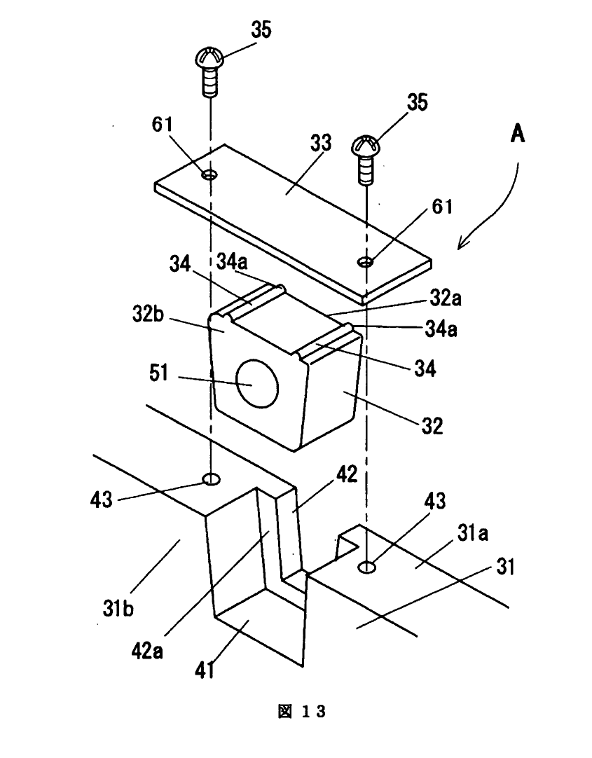

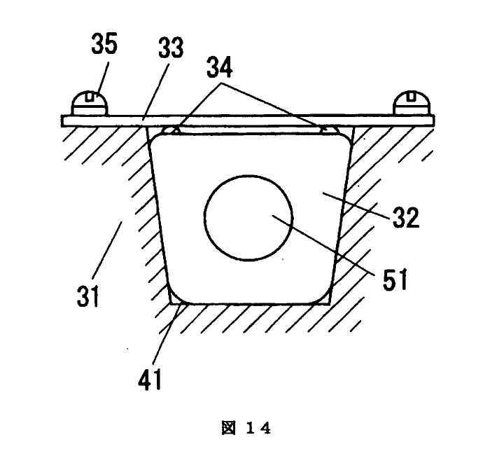

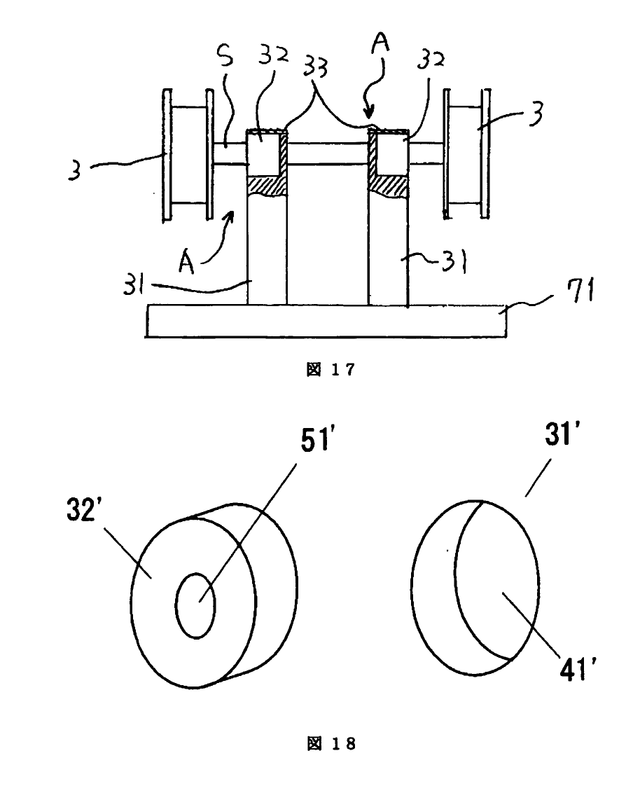

It is preferable that the bearing fitting concave portion and the sliding bearing portion are formed in a multiangular as viewed from an axial direction. Hereinafter, an elevator having the sliding bearing of the present invention mainly with respect to the sliding bearing will be described with reference to the drawings. At first, a ninth embodiment will be described with reference to FIG. 6, FIG. 13, FIG. 14, and FIG. 17.

As shown in FIG. 6 and FIG. 17, a pair of right and left winders 3 is supported by one rotating shaft S, and the rotating shaft S is supported on a pair of baring tables 31 secured on a support plate portion 71 as a member configuring the elevator body 1. On respective bearing tables 31, a sliding bearing A for fitting internally and supporting the rotating shaft S to rotate freely is provided.

As shown in FIG. 13, the sliding bearing A is configured in such a manner that a bearing fitting concave portion 41 is formed on a bearing table 31 so as to open upward, a sliding bearing portion 32 forming an acceptance portion 51 through which the rotating shaft S is inserted is fit from the upper part into the bearing fitting concave portion 41, and a cover portion 33 is secured on the bearing table 31 so as to weld the cover portion 33 with pressure.

As shown in FIG. 13, the bearing table 31 is made of aluminum die-casting that is formed as a wall having a prescribed thickness in an axial direction. An upper end surface 31a of the bearing table 31 is formed on a substantially horizontal surface, and on the bearing table 31, the bearing fitting concave portion 41 penetrating in the axial direction and opening upward is formed. The bearing fitting concave portion 41 is formed in a trapezoid that the right and left width are slightly wider upward as viewed from an axial direction. In addition, in this bearing fitting concave portion 41, a positioning part 42 shaped in an inner flange is formed at one side end boarder of the axial direction and the sliding bearing portion 32 to be fit in the bearing fitting concave portion 41 is positioned.

The sliding bearing portion 32 is made of a synthetic resin mainly composed of PPS, and its outline form is substantially the same as the bearing fitting concave portion 41. Further, in detail, a shape of the sliding bearing portion 32 as viewed from the axial direction is substantially the same as the shape of the bearing fitting concave portion 41 as viewed from the axial direction, upper and lower heights of the sliding bearing portion 32 are the same as or slightly lower than the upper and lower heights of the bearing fitting concave portion 41, and an upper end surface 32a of the sliding bearing portion 32 is on the same level as the upper end surface 31a of the bearing table 31 or is located slightly lower than the upper end surface 31a of the bearing table 31 upon fitting the sliding bearing portion 32 in the bearing fitting concave portion 41. In addition, the thickness of the sliding bearing portion 32 in the axial direction is substantially the same as a distance between a side end surface 31b at the side where the positioning part 42 of the bearing table 31 and an inner side end surface 42a of the positioning part 42, and an outer side end surface 32b of the sliding bearing portion 32 that is positioned by fitting the sliding bearing portion 32 in the bearing fitting concave portion 41 and abutting the sliding bearing portion 32 against the positioning part 42 is on the substantially same level as the side end surface 31b of the bearing table 31.

On the sliding bearing portion 32, the rotating shaft S is inserted inside thereof and the acceptance portion 51 for supporting this rotating shaft S is formed. This acceptance portion 51 is formed so that its inner diameter is slightly larger than the outer diameter of the rotating shaft S. In the meantime, the sliding bearing of the present embodiment is an oil-less bearing using a lubricating ability of the sliding bearing portion 32 itself made of a synthetic resin.

In this sliding bearing portion 32, a projection part 34 that is protruded upward on the upper end surface 32a is secured by the cover portion 33 as welded with pressure downward, and the detail thereof will be described below.

The projection part 34 that is protruded upward on the upper end surface 32a of the sliding bearing portion 32 is formed in such a manner that an upper end portion 34a of the projection part 34 is located upper than the upper end surface 31a of the bearing table 31 upon fitting the sliding bearing portion 32 in the bearing fitting concave portion 41. The projection part 34 according to the present embodiment is formed as protruded from the upper end surface 31a of the bearing table 31 by 0.3 mm.

On the other hand, the cover portion 33 is shaped in a flat plate, the cover portion 33 is formed so that its length is made longer than the length in a right and left direction of the bearing fitting concave portion 41 (a horizontal direction orthogonal to the axial direction), and a fixing device insert hole 61 is formed in the vicinity of the opposite side end portions in a right and left direction. In addition, a fixing hole 43 is formed on the upper end surface 31a of the bearing table 31 corresponding to the fixing device insert hole 61.

Upon fixing the sliding bearing portion 32 on the bearing table 31, at first, fitting the sliding bearing portion 32 into the bearing fitting concave portion 41 of the bearing table 31 from the upper part and abutting it against the positioning part 42, the sliding bearing portion 32 is positioned. Then, the flat-platy cover portion 33 is arranged upward and a fixing device 35 is inserted into the fixing device insert hole 61 of the cover portion 33 from the upper part so as to screw the fixing device 35 through the fixing hole 43 formed on the upper end surface 31a of the bearing table 31. In this case, the projection part 34 formed on the upper end surface 32a of the sliding bearing portion 32 is located upper than the upper end surface 31a of the bearing table 31, so that when the flat-platy cover portion 33 is attached on the upper end surface 31a of the bearing table 31, the projection part 34 is crashed not only by elastic deformation but also by plastic deformation, and thereby, the sliding bearing portion 32 is solidly put and fixed between the bearing table 31 and the cover portion 33.

In addition, in the sliding bearing A according to the ninth embodiment, two projection parts 34 are disposed in parallel in the axial direction. These two projection parts 34 are provided respectively at the opposite sides of a portion where the acceptance portion 51 of the sliding bearing portion 32 is formed as viewed from a flat plane. Thereby, it is possible to reduce deformation of the acceptance portion 51 and lowering of a rotation efficiency of the rotating shaft S can be prevented. Further, a fixing force is obtained at the both right and left sides, so that the sliding bearing portion 32 can be safely fixed.

According to the above-described configuration, the sliding bearing A is structured by using the bearing table 31 made of aluminum die-casting forming the trapezoidal bearing fitting concave portion 41 thereon and the sliding bearing portion 32 with the same shape as this bearing fitting concave portion 41, and thereby, it is possible to make a fitting portion of the bearing table 31 and the sliding bearing portion 32 (namely, the outer surface of the sliding bearing portion 32 and the inner surface of the bearing fitting concave portion 41 of the bearing table 31) not into a curved surface but into a flat surface. As a result, accuracy of measuring and accuracy of management of measuring are improved.

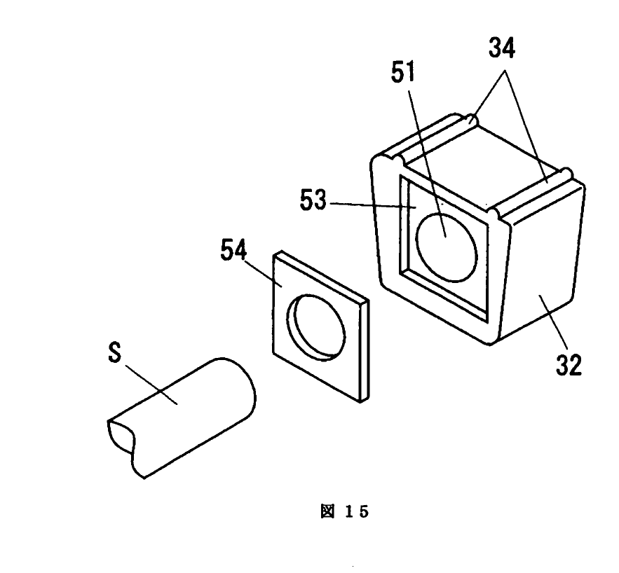

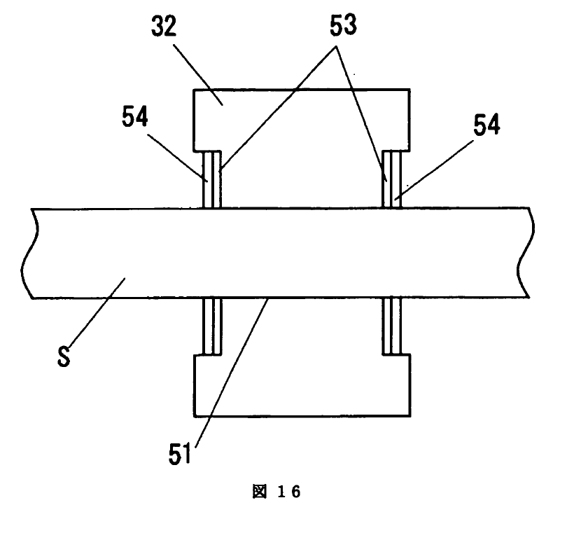

In the next place, with reference to FIG. 15 and FIG. 16, a tenth embodiment of the present invention will be described below. The sliding bearing A according to this embodiment is provided with a seal (or a filter) so as to be available in an adverse environment that dust is floating in air.

As shown in FIG. 15, at the opposite end portions in the axial direction of the sliding bearing portion 32, a concave portion 53 opening to the outside is formed on the acceptance portion 51 across the entire periphery of the inner surface, and a filter for preventing dust 54 made of a polyester film is provided on this concave portion 53 so as to closely contact the rotating shaft S. The concave portion 53 is formed as a square as viewed in the axial direction as shown in FIG. 16, however, the shape of the concave portion 53 is not particularly limited.

Thus, no foreign matter gets mixed in the acceptance portion 51 of the sliding bearing, so that it is possible to hold the rotating shaft S stably for a long period of time.

Further, in the elevator of the present invention, all of the above-described tension adjuster, jumping-out prevention member, and sliding bearing may be provided. In addition, the elevator of the present invention may be configured so as to have the above-described jumping-out prevention member and sliding bearing.

The elevator of the present invention is based on the inventions disclosed in Japanese Patent Application No. 2002-120712 (filed on Apr. 23, 2002), Japanese Patent Application No. 2002-120713 (filed on Apr. 23, 2002), and Japanese Patent Application No. 2002-182036 (filed on Jun. 21, 2002).

### INDUSTRIAL APPLICABILITY

According to the present invention, the tension adjuster for substantially equalizing the tensions of respective suspenders by acting on the respective suspenders located between the suspender outlet of the elevator body and the winder is provided, so that it is possible to hold the elevating/lowering section by the independent plural suspenders without inclination. As a result, the elevating/lowering section can be moved up and down in a stabilized attitude and safety is enhanced against cutting and dropping of the suspender. In addition, the present invention can provide the elevator, whereby the belt suspender can be prevented from being twisted when the elevating/lowering section turns over while lowering, the accuracy of measuring and the accuracy of management of measuring of the rotating shaft of the winder are improved, and the shaft can be held stably for a long period of time.

1. An elevator comprising an elevator body secured to a building structure and provided with a winder for winding a plurality of suspenders, and an elevating/lowering section being suspended to move freely up and down by the plurality of suspenders led out from the suspender outlet of the elevator body;
wherein the elevator further comprises a tension adjuster for substantially equalizing the tensions of respective suspenders by acting on the respective suspenders located between the suspender outlet of the elevator body and the winder.

2. The elevator according to claim 1,
wherein the tension adjuster is provided with a change-direction member for changing a direction of the suspender to move freely for each suspender between the suspender outlet of the elevator body and the winder, and a spring body with a substantially equal spring constant for adding a return force corresponding to the movement of each change-direction member thereto, respectively.

3. The elevator according to claim 1,
wherein there are two suspenders, the tension adjuster is provided with a change-direction member for changing a direction of the suspender for each suspender between the suspender outlet of the elevator body and the winder, and the change-direction members of respective suspenders united into one body by the same shaft is provided with a support member for supporting the shaft to swing freely with a center portion between the change-direction members of this shaft as a supporting point.

4. The elevator according to claim 1,
wherein there are two suspenders, a first change-direction member for changing the direction of the suspender between the suspender outlet of the elevator body and the winder is provided, the tension adjuster comprises second change-direction members located between the first change-direction member and the winder, which change the direction of the suspender and are united into one body each other by the same shaft, and a support member for supporting the shaft to swing freely with a center portion between the second change-direction members of the shaft as a supporting point.

5. The elevator according to claim 4,
wherein the second change-direction member is provided with a spring body, which is movably provided in an opposite direction of a support side of the support member and which applies a force to the opposite direction of the support side of the support member together with the shaft; and the second change-direction member is further provided with a switch operating as abutting against the shaft when the tension of the suspender is made small and the second change-direction member moves with the force of the spring body applied thereto so as to stop winding off of the suspender from the suspender by this switch.

6. The elevator according to claim 4,
wherein in the first change-direction member, the shaft is held to move freely by a spring body to apply a force to the opposite direction of the side pressed by the tension of the suspender; and the first change-direction member is provided with a switch operating as abutting against the shaft when a force more than a set tension is applied to the suspender and the shaft pushes down the spring body to move the spring body so as to stop winding of the suspender into the winder by this switch.

7. The elevator according to claim 3,
wherein the change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides.

8. The elevator according to claim 4,
wherein the second change-direction member has a rotating body rotating with the shaft inserted therethrough, and a shaft inserted portion of the rotating body is shaped in a taper so that its diameter is the smallest at the substantial center portion and the diameter becomes gradually larger toward the opposite sides.

9. The elevator according to claim 1,
wherein the two suspenders are two belts and the elevator is provided with a jumping-out prevention member for preventing each suspender from jumping out to the outside of the elevating/lowering section when the elevating/lowering section turns over in a direction to wind these two suspenders.

10. The elevator according to claim 9,
wherein the jumping-out prevention member comprises a wall body that is disposed along the side surface at the outside of a suspender attached portion for attaching the suspender of the elevating/lowering section.

11. The elevator according to claim 9,
wherein the jumping-out prevention member comprises a bar member that is arranged in a substantially horizontal direction at the outside of the suspender attached portion for attaching the suspender of the elevating/lowering section.

12. The elevator according to claim 9,
wherein the jumping-out prevention member comprises a bar member that is arranged in a substantially vertical direction at the outside of the suspender attached portion for attaching the suspender of the elevating/lowering section.

13. The elevator according to claim 1,
wherein a bearing fitting concave portion opening upward is formed on a bearing table to be used as a rotating shaft of the winder; a sliding bearing portion forming an acceptance portion through which the rotating shaft is inserted is fit in the bearing fitting concave portion; and a sliding bearing for securing the sliding bearing portion fit in the bearing fitting concave portion from the upper part therein by a cover portion is mounted; and
wherein the bearing fitting concave portion and the sliding bearing portion are formed in a multiangular as viewed from an axial direction.

14. The elevator according to claim 13,
wherein a projection part to be welded with pressure downward on an upper end portion of the sliding bearing portion by a cover portion is provided at a place evading the rotating shaft as viewed from a flat plane.

15. The elevator according to claim 14,
wherein the plural projection parts are linearly provided in substantially parallel.

16. The elevator according to claim 13,
wherein a concave portion opening to the side is formed at both ends in the axial direction and across the entire periphery of the acceptance portion of the sliding bearing portion, and a filter for preventing dust is provided on the concave portion so as to closely contact the rotating shaft.

17. The elevator according to claim 9,
wherein a bearing fitting concave portion opening upward is formed on a bearing table to be used as a rotating shaft of the winder; a sliding bearing portion forming an acceptance portion through which the rotating shaft is inserted is fit in the bearing fitting concave portion; and a sliding bearing for securing the sliding bearing portion fit in the bearing fitting concave portion from the upper part therein by a cover portion is mounted; and
wherein the bearing fitting concave portion and the sliding bearing portion are formed in a multiangular as viewed from an axial direction.

18. The elevator according to claim 17,
wherein a projection part to be welded with pressure downward on an upper end portion of the sliding bearing portion by a cover portion is provided at a place evading the rotating shaft as viewed from a flat plane.

19. The elevator according to claim 18,
wherein the plural projection parts are linearly provided in substantially parallel.

20. The elevator according to claim 17,
wherein a concave portion opening to the side is formed at both ends in the axial direction and across the entire periphery of the acceptance portion of the sliding bearing portion, and a filter for preventing dust is provided on the concave portion so as to closely contact the rotating shaft.
